(19) United States
(12) Patent Application Publication
(10) Pub. No.: US 2025/0127229 A1
(43) Pub. Date: Apr. 24, 2025

(54) AEROSOL GENERATING DEVICE

(71) Applicant: NICOVENTURES TRADING LIMITED, London (GB)

(72) Inventors: Dean COWAN, London (GB); Matthew HODGSON, London (GB); Sydney TAVERN, London (GB)

(21) Appl. No.: 18/722,257

(22) PCT Filed: Dec. 19, 2022
(86) PCT No.: PCT/EP2022/086774

§ 371 Date: Jun. 20, 2024

(30) Foreign Application Priority Data
Dec. 22, 2021 (GB) 2118725.7

(51) Int. Cl. A24F 40/465

(52) U.S. Cl. CPC A24F 40/465

(57) ABSTRACT

An aerosol generating device generates an aerosol from aerosol generating material. The device has a device body with a power supply, a heating module that has a heating chamber and a heating element. The heating chamber receives a portion of an article containing aerosol generating material, and the heating element heats the heating chamber. The heating module is separable from the device body.

### RELATED APPLICATIONS

The present application is a National Phase entry of PCT Application No. PCT/EP2022/086774 filed Dec. 19, 2022, which claims priority to GB Application No. 2118725.7 filed Dec. 22, 2021, each of which is hereby incorporated by reference in their entirety.

### TECHNICAL FIELD

The present invention relates to aerosol generating device for generating an aerosol from aerosol-generating material. The present invention also relates to a heating module, an aerosol generating system, and a modular aerosol generating device system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol generating device for generating an aerosol from aerosol-generating material comprising a device body comprising a power supply, a heating module comprising a heating chamber configured to receive at least a portion of an article containing aerosol-generating material, and a heating element configured to heat the heating chamber, wherein the heating module is separable from the body.

The device may comprise an electrical connection configuration arranged to electrically connect the heating module with the power supply of the device body.

The device may comprise a mount configured to releasably mount the heating module with the device body.

The mount may connect an end of the device body with an end of the heating module. The electrical configuration may be on the mount.

The mount may comprise at least one of a magnet configuration, a press fit configuration, a bayonet configuration and a threaded configuration.

The heating element may comprise a material heatable by a varying magnetic field.

The heating module may comprise an inductor coil, and the inductor may be configured to generate a varying magnetic field.

The inductor coil may extend around the heating element. The inductor coil and heating element may be fixedly mounted.

The inductor coil and heating element may be integrally formed in the heating module.

The heating element may protrude in the heating chamber. The heating element may be elongate.

The heating element may comprise a wall of the heating chamber.

The heating module may comprise a peripheral wall defining at least part of an external wall of the device.

The heating module may comprise a secondary body arranged to mount to the device body. The secondary body may comprise a mouthpiece.

The heating module may be configured to extend in the secondary body. The device body and the secondary body may be configured to enclose the heating module.

The device may comprise a cavity in the secondary body configured to receive at least part of the heating module. The cavity may be configured to receive at least part of the portion of an article containing aerosol-generating material. The cavity may extend to an opening in the secondary body through which an article is arranged to protrude from the aerosol generating device. An airpath may extend from the cavity to an opening on a peripheral face of the secondary body. The airpath may be a bore.

According to an aspect, there is provided a heating module arranged to mount with a device body of an aerosol generating device, the heating module comprising a receptacle defining a heating chamber configured to receive at least a portion of an article containing aerosol-generating material, a heating element arranged to heat the heating chamber, and an electrical connection configuration arranged to electrically connect the heating module with a power supply of the device body.

According to an aspect, there is provided a system comprising the aerosol-generating device or the heating module and an article containing aerosol-generating material.

According to an aspect, there is provided a modular aerosol-generating device system comprising an aerosol-generating device for generating an aerosol from aerosol-generating material comprising a primary device body comprising a power supply, a heating module comprising a heating element configured to heat at least a portion of an article containing aerosol-generating material, and a secondary device body configured to at least partially enclose at least a portion of an article containing aerosol-generating material, wherein the primary device body, heating module and secondary device body are separable.

The heating module may comprise a heating chamber configured to receive at least a portion of an article containing aerosol-generating material.

The secondary body may comprise a cavity configured to receive at least part of the portion of an article containing aerosol-generating material. The cavity may extend to an opening in the secondary body through which an article is arranged to protrude from the aerosol generating device. An airpath may extend from the cavity to an opening on a peripheral face of the secondary body. The airpath may be a bore. The secondary body may be a mouthpiece.

The heating module may be a first heating module comprising a first heating element, and a second heating module comprising a second heating element. The first heating element may have a different configuration to the second heating element. The first heating element may have a first length and the second heating element may have a second length. The first and second heating modules may be interchangeable.

The secondary body may be a first secondary body and the system may further comprise a second secondary body. The first secondary body may comprise a first cavity configured to receive at least part of the portion of a first article containing aerosol-generating material and the second secondary body may comprise a second cavity configured to receive at least part of the portion of a second article containing aerosol-generating material. The first and second cavities may comprise different configurations. The first cavity may have a different volume from the second cavity.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a schematic cross-sectional view of an aerosol generating system;

FIG. 2 shows a schematic cross-sectional partially exploded view of the system of FIG. 1;

FIG. 3 shows a schematic cross-sectional of the heating module of FIGS. 1 and 2;

FIG. 4 shows a schematic cross-sectional exploded view of the system of FIG. 1

FIG. 5 shows a schematic cross-sectional of another configuration of the aerosol generating system of FIG. 1; and

FIG. 6 shows a schematic cross-sectional of another configuration of the aerosol generating system of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any plant-based material, such as tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

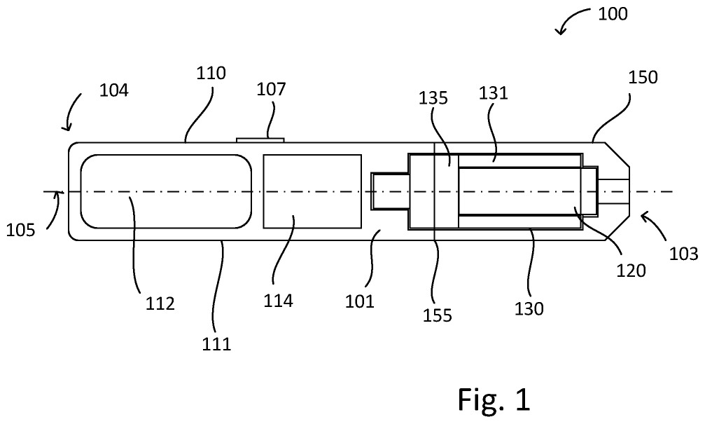

FIG. 1 shows a cross sectional view of an aerosol generating system 100. The system 100 comprises an aerosol generating device for generating aerosol from an aerosol generating material, and a replaceable article 120 comprising the aerosol generating material. The device can be used to heat the replaceable article 120 comprising the aerosol generating material, to generate an aerosol or other inhalable material which can be inhaled by a user of the system 100.

The device comprises a device body 110 which surrounds and houses various components of the device. The device body 110 is elongate. The device body 110 acts as a main body of the system and is arranged to be held by a user.

The device comprises a heating module 130. The heating module defines a receptacle for receiving at least a portion of the article 130. The heating module 130 comprises a heating chamber 132 and a heating element 134. At least a portion of the article 130 is receivable in the heating chamber 132. The heating chamber 132 defines a heating zone which is configured to be heated to heat the aerosol generating material. The heating module 130 is separable from and arranged to mount to the device body 110.

The device comprises a secondary body 150. The secondary body 150 acts as a mouthpiece 150. The mouthpiece 150 is separable from and arranged to mount to the device body 110. The mouthpiece 150 is elongate. The mouthpiece 150 is configured to receive part of the heating module 130. In embodiments, as described below, the mouthpiece 150 may be omitted.

The device body 110 defines a longitudinal axis 105, along which the device body 110, heating module 130, and mouthpiece 150 are aligned on assembly of the system 100. The article 120 may also be aligned along the axis 105 in use.

The device body 110 comprises a user-operable control element 107, such as a button or switch, which operates the device when operated, e.g. pressed. For example, a user may activate the device by pressing the switch.

The device body 110 comprises a power supply 112. The power supply 112 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The device body 110 comprises a controller 114. When the device is assembled the power supply 112 is electrically coupled to the heating module 130 to supply electrical power when required and under control of the controller 114 to heat the aerosol generating material. The control circuit 114 is configured to activate and deactivate the heating module 130 based on a user operating a control element.

The heating module 130 is configured to heat the aerosol-generating material of the article 120 inserted into the device, such that an aerosol is generated from the aerosol generating material. The power supply 112 supplies electrical power to the heating module 130, and the heating module 130 converts the supplied electrical energy into heat energy for heating the aerosol-generating material.

The heating module 130 is enclosed by the device body 110 and the mouthpiece 150, acting as a secondary body. This may aid insulation of the system 100 to maintain low external temperatures of the system 100. Such an arrangement may aid the efficiency of the system 100 by encompassing the heating zone of the heating module 130.

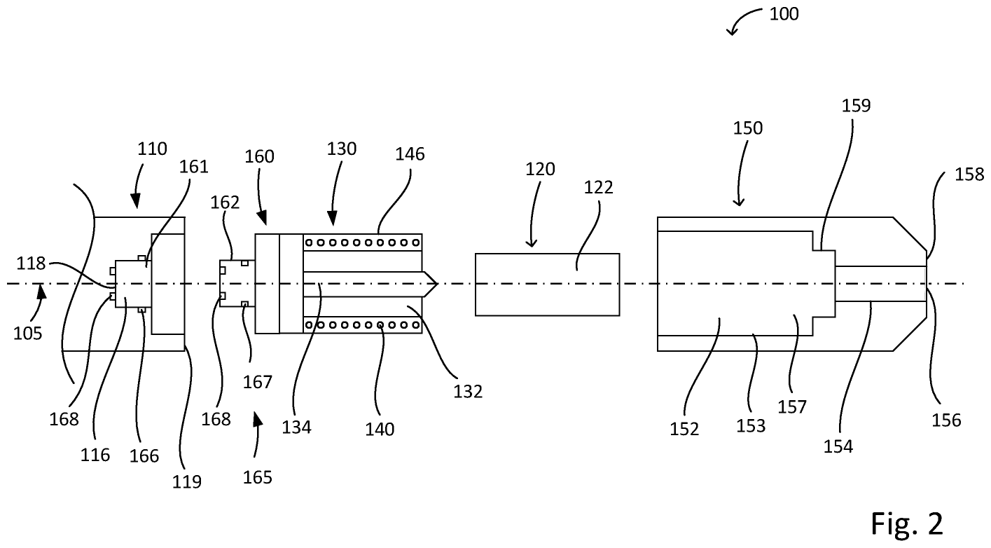

FIG. 2 shows an exploded view of the system 100 along the axis 105. In FIG. 2, the system 100 is shown in a disassembled condition with each of the device body 110, the heating module 130, the article 120, and the mouthpiece 150 separated from each other. The mouthpiece 150 is separable from the remainder of the system 100 to provide for straightforward insertion and removal of the article 120 in the device.

The mouthpiece 150 provides an opening 156 through which aerosol is drawn from the device by a user. The opening 156 defines an outlet for an air path through the device. The air path is defined from an air inlet to the air outlet. The air inlet (not shown) in embodiments is in one or more of the device body 110, the heating module 130 and the mouthpiece 130. In embodiments, the air inlet is defined between two components. In the present embodiment, the air inlet is defined at a juncture 155 of the device body 110 and the mouthpiece 150. As such, the air inlet is easily formed.

The end of the device closest to the opening 156 is known as the proximal end (or mouth end) 103 of the device because, in use, it is closest to the mouth of the user. The opening 156 is arranged along the longitudinal axis 105. The other end of the device furthest away from the opening 156 may be known as the distal end 104 of the device because, in use, it is the end furthest away from the mouth of the user. Features may be described herein relative to each in view of this orientation.

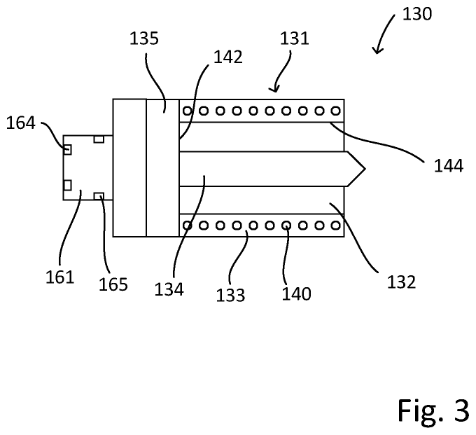

The device body 110 comprises a recess 116 in which the heating module 130 is partially received. The heating module 130 is removably received by the recess 116. The device body 110 defines a proximal side 119 on which the heating module 130 is removably attached. The heating module 130 is partially inserted into the recess 116 such that it protrudes away from the device body 110 in a proximal direction. The heating module is shown in more detail in FIG. 3. The device body 110 defines a first housing 111. The first housing 111 houses components of the device. The power supply 112 and the controller 114 are housed in the device body 110. A mount 160 mounts the device body 110 and the heating module 130. The mount 160 separably mounts the heating module 130 on the device body 110. The heating module 130 is configured to be retained on the device body 110 when assembled. The mount 160 mounts a distal end of the heating module 130 with a proximal end of the device body 110.

The mount 160 comprises a first mount portion 161 on device body 110 and a second mount portion 162 on the heating module 130. The first and second mount portions 161, 162 interact to retain the heating module 130 on the device body 162. The first and second mount portions 161, 162 align the heating module 130 and the device body 110. The first mount portion 161 is in the recess 116. In embodiments, the first mount portion 161 is on the proximal side 119 of the device body 110. The first mount portion 161 comprises a female fitting. The second mount portion 162 comprises a corresponding male fitting. In embodiments the arrangement is reversed.

The mount 160 comprises an attachment configuration 165. The attachment configuration 165 acts to releasably retain the device body 110 and the heating module 130. The attachment configuration 165 comprises a magnetic attachment configuration. In embodiments, the attachment configuration 165 comprises an alternative or complimentary releasable attachment arrangement such as at least one of a press fit configuration, a bayonet configuration and a threaded configuration. The attachment configuration 165 comprises a first attachment 166 on the device body 110 and a corresponding second attachment 167 on the heating module 130. As shown, the first attachment 166 and second attachment 167 are on the first mount portion 161 and second mount portions 162 respectively.

The heating module 130 is inserted into the recess 116 such that the heating module 130 is located and removable secured to the device body 110.

An electrical connection configuration 168 is arranged to electrically connect the heating module with the power supply of the device body. The electrical connection configuration 168 is in electrical connection with the power supply 112. electrical connection configuration 168 is on the mount. On connection of the heating module 130 with the device body 110, the electrical connection configuration 168 moves into electrical contact.

The heating module 130 comprises various components to heat the aerosol generating material of the article 120 via an inductive heating process. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating element) suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application.

Referring now to FIG. 3 in particular, the heating module 130 comprises the heating chamber 132 configured and dimensioned to receive at least a portion of the article 120 to be heated. The heating chamber 132 defines the heating zone. The article 120 is generally cylindrical, and the heating chamber 132 is correspondingly generally cylindrical in shape. However, other shapes would be possible. The heating chamber 132 is defined by the inner surfaces of an end wall 142 and a peripheral wall 144. The end wall 142 forms a closed end of the heating chamber 132 and acts as a base of the heating chamber 132. The peripheral wall 144 is generally tubular and extends along the longitudinal axis 105. However, other shapes would be possible.

The heating module 130 comprises a heating element 134. The heating element 134 is configured to heat the heating zone which is defined by the heating chamber 132. The heating element 134 is an induction heating element. That is, the heating element 134 comprises a material that is heatable by penetration with a varying magnetic field. The material that is heatable by penetration with a varying magnetic field acts as a susceptor. The susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

The heating module 130 comprises a magnetic field generator 131 which is configured to generate one or more magnetic fields that penetrate the susceptor so as to cause heating in the susceptor. The magnetic field generator 131 includes an inductor coil arrangement comprising an inductor coil 140, acting as an inductor element. The inductor coil 140 is a helical coil, however other arrangements are envisaged. The inductor coil 140 is in a heating module body 133 of the heating module. The inductor coil 140 and heating element 134 are integrally formed in the heating module body 133. The inductor coil and the heating element 134 may be separately formed and attached to the heating module body 133 to provide the heating module 130.

The heating element 134 extends in the heating chamber 132. The heating element 134, acting as a protruding element, protrudes in the heating chamber 132. The heating element 134 upstands from the end wall 142. The heating element 134 is spaced from the peripheral wall 144. The heating element 134 is positioned, in use, within the article 120. The heating element 134 is configured to heat aerosol generating material of an article 120 from within. The heating element 134 extends into the heating chamber along the longitudinal axis 105. The heating element may also be off axis or non-parallel to the axis 105. In embodiments, the heating element is positioned around the article 120 such that it surrounds the article 120 and is between the article 120 and the inductor coil 140.

The inductor coil 140 is external to the heating chamber 132. The inductor coil 140 extends around the peripheral wall 144 of the heating chamber 132. The inductor coil 140 extends around at least a portion of the heating element 134, acting as a susceptor. The inductor coil 140 is configured to generate a varying magnetic field that penetrates the heating element 134. The inductor coil 140 may be helical and is arranged coaxially with the longitudinal axis 105. Other types of inductor coil may be used.

The heating module 130 is open at its proximal end such that the article 120 can be received by the heating chamber 132. The article 120 may be fully or partially inserted into the device by inserting into the heating module. In use, the article may protrude from the proximal end of the heating module 130 along the longitudinal axis 105.

The mouthpiece 150 is arranged such that it fits around and encloses the heating module 130 along with the device body 110. The mouthpiece may comprise an attachment arrangement (not shown) to removably attach the mouthpiece 150 to the device body 110. The mouthpiece comprises a cavity 152 to receive at least part of the heating module 130. The cavity 152 surrounds the portion of the heating module 130 that protrudes from the device body 110 when the heating module 130 is attached to the device body 110. The recess 116 of the device body 110 and the cavity 152 in the secondary body 150 provide a receiving space for the heating module 130.

A distal end of the mouthpiece 150 attaches to a proximal end of the device body 110. The mouthpiece 150 and device body 110 may be attached by attachment arrangement such as a magnet configuration, a press fit configuration, a bayonet configuration or a threaded configuration. The cavity 152 receives the heating module 130. The cavity 152 defines a heating module receiving space 157 and an article end receiving space 159. Upon assembly, the heating module 130 extends in the heating module receiving space 157. A protruding end of the article 120 is received in the article end receiving space 159. The article end receiving space 159 received and holds the article 120 in place within the mouthpiece 150, and the protruding portion of the article 120 allows for removal of the article 120 by the user.

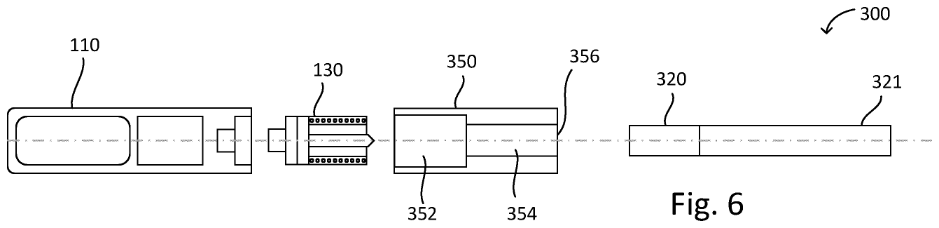

An airpath 154 connects the cavity 152 and the opening 156. The airpath may be a bore. The airpath 154 has a smaller diameter than the cavity 152. As such, the article 120 is retained by the mouthpiece 150. In embodiments, the cavity 152 extends along the longitudinal axis 105 to form the opening 156 in the mouthpiece. In such an embodiment, the article may be inserted through the opening 156 for heating by the device, as shown by the embodiment of FIG. 6.

The cavity 152 is defined by an internal wall 153. The heating module 130 and the cavity 152 have a corresponding shape. The heating module 130 and the cavity 152 are cylindrical. The heating module 130 and the cavity 152 may be another shape or configuration that allow the heating module 130 to fit within the cavity 152. The inner face of the internal wall 153 may be in contact and substantially parallel with the external wall of the heating module 130.

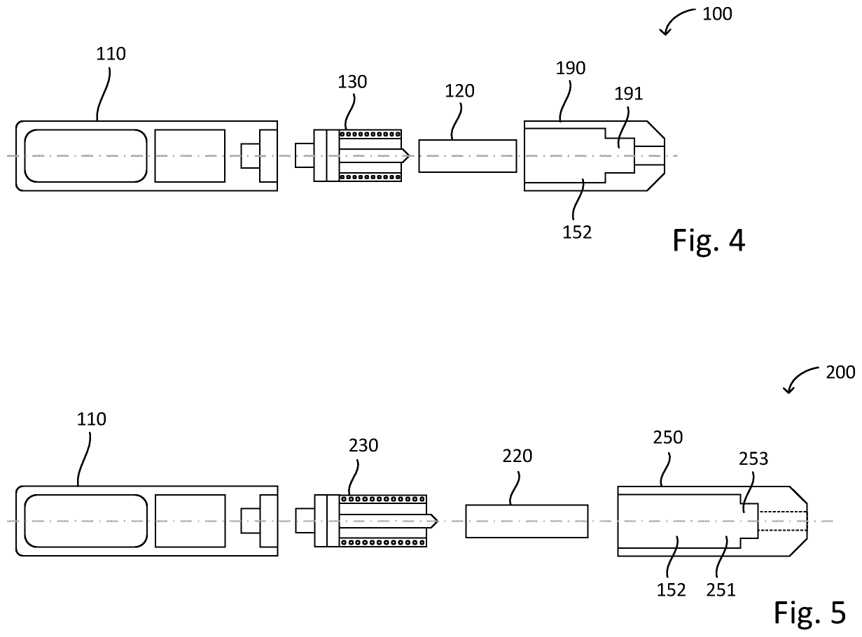

In this embodiment, the mouthpiece 150 is removed before inserting the article 120 into the heating module 130. In use, the user can remove the mouthpiece 150 and the heating module 130 such that the heating module 130 and mouthpiece 150 can be replaced by alternative heating modules 230, 430 and mouthpieces 250, 350 such as those shown in FIGS. 4, 5, 6, and 7. The configurations of 6 and 7 allow the mouthpiece 350 to remain attached during insertion and removal of the article 320. The configuration of these embodiments is generally the same as described above and so a detailed description will be omitted.

FIG. 4 shows a configuration in which the first mouthpiece 150 is replaced by a second mouthpiece 190. Such mouthpieces are interchangeable. The second mouthpiece 190 comprises an extended cavity 152 in which the depth of an article end receiving space 191 is greater than the depth of the article end receiving space 159 of the first mouthpiece 150. As such, different length articles may be used with the same device body 110. Other spatial dimensions may differ between mouthpieces.

FIG. 5 shows a configuration in which the first heating module 130 is replaced by another second heating module 230. Such heating modules 130, 230 are interchangeable. The first and second heating modules 130, 230 have differing characteristics. As shown in FIG. 5, the length of the second heating module 230 is greater than the length of the first heating module 130. As such, different length articles may be used with the same device body 110. Different heating profiles may be applied. Other characteristics may differ between heating modules.

Referring now to FIG. 6, the system 300 shows a configuration in which the first secondary body 150, acting as a mouthpiece, is replaced by a second secondary body 350. This second secondary body 350 does not act as a mouthpiece. The secondary body 350 comprises an opening 356 through which the article 320 is inserted from the proximal end of the device. The article 320 acts as the mouthpiece at a proximal article end 321. The proximal article end 321 extends from the secondary body opening 356 along the longitudinal axis 105 such that the proximal article end 321 extends proximally beyond the secondary body 350. In this embodiment, the secondary body 350 is retained in position when the article 320 is inserted or removed from the system 300. The cavity 352 which receives the heating module 130 may extend to the opening 356 in the secondary body 350. The article 320 is arranged to protrude through the opening 356. An airpath 354 extends from the cavity 352 to the opening 356 on a peripheral face of the secondary body 350. In embodiments, the secondary body is omitted. The heating module comprises an external peripheral wall 446 forming an external surface of the device. The article 320 of FIG. 6 or similar articles are used with such a configuration.

The user can remove and replace the heating modules 130, 230 such that interchangeable and/or replacement mouthpieces 150, 250, 350 and articles 120, 220, 320 can be used. This helps to allow the user to create different heating profiles for the device without requiring a whole new device. The also has an environmental benefit of reducing waste. The heating modules 130, 230 can be changed and an appropriate mouthpiece 150, 250, 350 for the heating module can be chosen. Different mouthpieces 150, 250, 350 can provide different experiences for the user and allow for different shapes or sizes of heating module 130, 230 to be used in combination with the device body 110. Different sized articles 120, 220, 320 can also be used in combination with the different heating modules and mouthpieces. The heating modules 130, 230 may differ in external size or shape. Different heating modules may have different size, shape or volume heating chambers to provide a different heating profile of an article. Different heating modules may also have different heating capabilities. The heating module may have two or more coils. The heating module may have a heating element external to the article, as previously described. The heating element may have a different arrangement to as described. Different mouthpieces will have different external shapes or sizes. The mouthpiece may have a different length air pathway or different sized opening. Differences in internal dimensions of the mouthpiece can create a different user experiences. Different mouthpieces can be used with correspondingly shaped heating modules. Different mouthpieces can also provide a different aesthetic appearance of the device for a different user experience.

The device body 110 can receive different heating modules, different mouthpieces and different articles. The heating module 130, 230 of any embodiment may be fully or partially recessed within the device body 110.

In use, the system 100, 200, 300 is assembled by attaching a selected one of the heating modules 130, 230 to the device body 110, inserting a corresponding article 120, 220, 320 into the heating chamber 132, and attaching the corresponding secondary body 150, 250, 350 over the heating module 130, 230. In embodiments, such as shown in FIG. 6 the article 320 is inserted after the secondary body is attached to the device body 110.

In use, the user is able interchange the mouthpieces, articles and heating modules and attach the components to the same device body. The device body may be replaced. This interchangeability allows for different user experiences. The heating module 130, 230, 430 comprising a single unit allows for the modular aspect of the system 100, 200, 300 and allows the heating module 130, 230 to be interchangeable depending on user preference or in relation to design of other components.

The heating module 130, 230 is attached to the device body by engaging the second mount portion 162 with the first mount portion 161. The electrical connection configuration 166 provides an electrical connection between the heating module 130 and the power supply 112.

In the above described embodiments, the heating arrangement is an inductive heating arrangement. In embodiments, other types of heating arrangement are used, such as resistive heating. The configuration of the device is generally as described above and so a detailed description will be omitted. In such arrangements the heating module 130 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material comprising:
a device body comprising a power supply;
a heating module comprising:
a heating chamber configured to receive at least a portion of an article containing aerosol-generating material, and
a heating element configured to heat the heating chamber;
wherein the heating module is separable from the device body.

2. The device of claim 1, comprising an electrical connection configuration arranged to electrically connect the heating module with the power supply of the device body.

3. The device of claim 1, comprising a mount configured to releasably mount the heating module with the device body.

4. The device of claim 3, wherein the electrical connection configuration is on the mount.

5. The device of claim 1, wherein the heating element comprises a material heatable by a varying magnetic field.

6. The device of claim 1, wherein the heating module comprises an inductor coil, and the inductor is configured to generate a varying magnetic field.

7. The device of claim 6, wherein the inductor coil is fixed relative to the heating element.

8. The device of claim 1, wherein the heating module comprises a peripheral wall defining at least part of an external wall of the device body.

9. The device of claim 1, wherein the heating module comprises a secondary body arranged to mount to the device body.

10. The device of claim 10, wherein the secondary body comprises a mouthpiece.

11. The device of claim 9, wherein the device body and the secondary body are configured to enclose the heating module.

12. The device of claim 9, comprising a cavity in the secondary body configured to receive at least part of the heating module.

13. (canceled)

14. A heating module arranged to mount with a device body of an aerosol generating device, the heating module comprising a receptacle defining a heating chamber configured to receive at least a portion of an article containing aerosol generating material, a heating element arranged to heat the heating chamber, and an electrical connection configuration arranged to electrically connect the heating module with a power supply of the device body.

15. An aerosol generating system comprising the aerosol generating device of claim 1.

16. A modular aerosol generating device system comprising an aerosol-generating device for generating an aerosol from aerosol-generating material comprising:
a primary device body comprising a power supply;
a heating module comprising a heating element configured to heat at least a portion of an article containing aerosol generating material; and
a secondary device body configured to at least partially enclose at least a portion of an article containing aerosol generating material;
wherein the primary device body, heating module and secondary device body are separable.

17. The system of claim 16, wherein the heating module comprises a heating chamber configured to receive at least a portion of an article containing aerosol-generating material.

18. The system of claim 16, wherein the secondary body comprises a cavity configured to receive at least part of the portion of an article containing aerosol generating material.

19. (canceled)

20. The system of claim 16, comprising an airpath extending from the cavity to an opening on a peripheral face of the secondary body.

21. (canceled)

22. The system of claim 16, wherein the heating module is a first heating module comprising a first heating element and the system further comprises a second heating module comprising a second heating element.

23. (canceled)

24. The system of claim 16, wherein the first and second heating modules are interchangeable.

25. (canceled)
